(19) United States
(12) Patent Application Publication
(10) Pub. No.: US 2016/0024950 A1
(43) Pub. Date: Jan. 28, 2016

(54) STEAM TURBINE

(71) Applicant: Robert Bosch GmbH, Stuttgart (DE)

(72) Inventors: Andreas Wengert, Backnang (DE); Hans-Christoph Magel, Reutlingen (DE); Wolfgang Stolper, Fellbach (DE); Nadja Eisenmenger, Stuttgart (DE); Frank Ulrich Rueckert, Stuttgart (DE); Steffen Buhl, Sachsenheim-Spielberg (DE); Thomas Steidten, Ludwigsburg (DE)

(21) Appl. No.: 14/773,422

(22) PCT Filed: Feb. 27, 2014
(86) PCT No.: PCT/EP2014/053820

§ 371 Date: Sep. 8, 2015

(30) Foreign Application Priority Data
Mar. 7, 2013 (DE) 10 2013 203 903.4

(51) Int. Cl. F01D 9/04; F01D 5/12; F01K 23/10

(52) U.S. Cl. CPC F01D 9/047; F01K 23/10; F01D 5/12; F05D 2220/31

(57) ABSTRACT

The invention relates to a steam turbine 5, in particular for utilizing the waste heat of an internal combustion engine, having at least one turbine housing, having a guide wheel 10 that has at least one nozzle, and having at least one rotor 6, wherein the nozzle is in the form of a duct 11 formed into the guide wheel 10. According to the invention, a steam turbine 5 is provided, the nozzles of which can be manufactured in a simple manner. This is achieved by virtue of the fact that the duct 11 has a constant width B and has a depth T that varies along the duct 11. In this way, the duct 11 can be produced by means of a single tool in a single working operation.

### BACKGROUND OF THE INVENTION

The invention relates to a steam turbine, in particular for using waste heat from an internal combustion engine, with at least one turbine casing, a guide wheel having at least one nozzle, and at least one rotor, and wherein the nozzle is designed as a duct introduced into the guide wheel.

The invention further relates to a method for producing a duct of a nozzle of a steam turbine.

Such a steam turbine is known from DE 10 2010 042 412 A1. This steam turbine is configured for using waste heat from an internal combustion engine and has the usual components in the form of a turbine casing, a guide wheel having at least two nozzles, and a rotor. The nozzles are designed as rectangular ducts and have a convergent and divergent cross section profile along the duct. In addition, the ducts are arranged in a central region of the guide wheel. Such a duct with a varying cross section profile is difficult to create. The special feature of the nozzles described in this document is that the at least two nozzles are configured for different load points of the rotor and can be switched on and off independently of one another.

### SUMMARY OF THE INVENTION

The invention is based on the object of providing a steam turbine with at least one nozzle arranged in a guide wheel, whose nozzles are simple to create. Furthermore, a corresponding production method is to be indicated.

This object is achieved in that the duct has a constant breadth B and a depth T which varies along the duct. This configuration has the advantage that a duct formed in this fashion is simple to create by virtue of the constant breadth B of the duct, since the depth T of the duct can easily be set by the penetration depth of the corresponding tool in the workpiece. The corresponding production method is substantially simpler than the method for producing a conventional duct, in which the breadth B of the duct varies through the duct on both sides of a central longitudinal plane. To that end, it is necessary to provide various tools and/or production steps in order to create a duct formed in that fashion.

In a development of the invention, the duct is arranged inclined at an angle β in the guide wheel. This inclination is adopted in order to orient the steam flowing through the nozzle onto the blades of the rotor in such a manner as to produce an optimum drive efficiency.

In a further configuration of the invention, the duct is arranged wound in the guide wheel. Such a wound duct can also be easily created for example using a pin-type milling tool whose diameter corresponds to the breadth B of the duct. In the case of such a wound duct, the angle β changes along the duct.

In a development of the invention, an inlet into the duct and an outlet from the duct are arranged wound with respect to a duct center part or a duct center. In this context, in particular the outlet or its orientation to the blades of the rotor is important for good efficiency of the steam turbine, while the orientation of the inlet plays a rather less important role in determining the efficiency. In that context, the outlet at the exit on the outlet side is oriented at the angle α.

In a further configuration of the invention, the angle a at the exit from the duct, at the transition to the rotor, is 15° with respect to the axial longitudinal axis x through the steam turbine. This angle α is matched to the shape of the rotor and can of course have other angles in the case of a different configuration of the rotor. In the case of a non-wound duct, the angles α and β are identical.

In a development of the invention, the nozzle is a de Laval nozzle. In particular using a de Laval nozzle, there arises the possibility of accelerating the steam to supersonic speed and thus to drive the rotor with steam accelerated to supersonic speed.

In a development of the invention, a number of nozzles are introduced into the guide wheel, on the external circumference thereof. This configuration permits an expedient incident flow onto the rotor over the entire circumference of the latter. It is furthermore possible, by virtue of the fact that the breadth B of the individual ducts is constant along the duct, for a greater number of nozzles to be arranged on the guide wheel than is possible in the case of a conventional nozzle. In addition, the constant breadth of the resulting webs between the ducts contributes to an increase in the strength of the guide wheel and thus to an improvement in the operational reliability of the steam turbine. Finally, the duct arranged on the external circumference is simple to produce.

In a development of the invention, the nozzles have a constant spacing A with respect to one another along the respective duct. This is in particular also the case for wound ducts.

In a further embodiment, a single tool is provided for creating the duct. This tool can for example be a milling disk which can be used for creating a straight duct. The milling disk has a thickness which corresponds to the breadth of the duct to be generated, while the depth of the duct to be machined into the rotor is determined by the penetration depth of the tool into the rotor. As has already been explained, however, a pin-shaped milling tool is also suitable for producing the duct, wherein such a milling tool is used in particular in the context of producing a wound duct.

Further advantageous embodiments of the invention can be found in the description of the drawings in which an exemplary embodiment of the invention, represented in the figures, is described in more detail.

### BRIEF DESCRIPTION OF THE DRAWINGS

In the figures:

FIG. 1 shows, in a schematic representation, a circuit of a system for using the waste heat from an internal combustion engine,

FIG. 2 shows, in an exploded three-dimensional view, an inlet volute, a guide wheel and a rotor of a steam turbine,

FIG. 3 is a detail view of a guide wheel into which four nozzles have been introduced, and

FIG. 4 is a diagrammatic representation of a normal and a redesigned de Laval nozzle.

### DETAILED DESCRIPTION

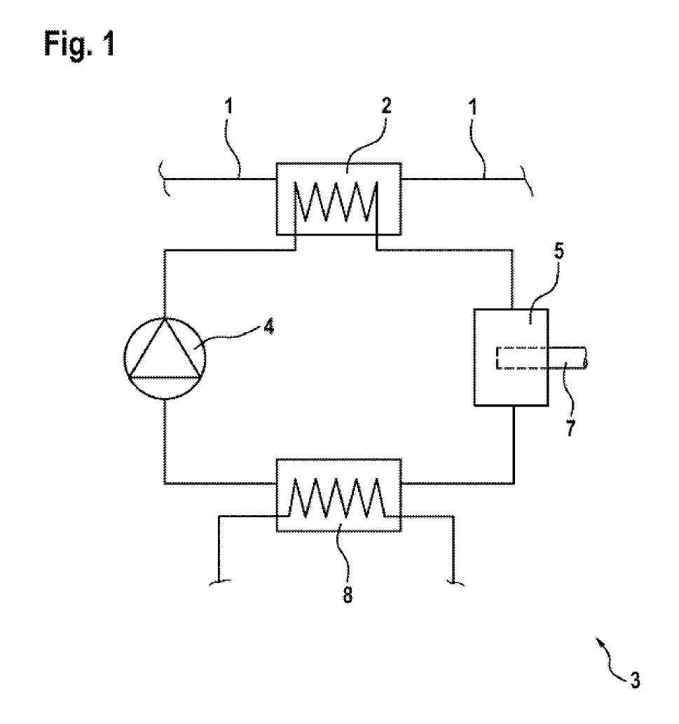

FIG. 1 shows, in a schematic representation, a system for using waste heat, in particular for recovering energy from a waste heat flow of an internal combustion engine. During operation of an internal combustion engine, the latter is supplied with fuel and combustion air which combust in the combustion chambers of the internal combustion engine during operation of the latter, producing heat, and move pistons in cylinders in order to generate a rotational movement of a crank shaft connected to the piston. The fuel injection system of the internal combustion engine is for example designed as a common rail injection system and the internal combustion engine is an auto-ignition internal combustion engine operated using diesel fuel. The waste heat flow of fuel and combustion air is evacuated via an exhaust line 1 and is guided through an evaporator 2. The evaporator 2 is for example designed as a pipe heat exchanger and has a number of pipes through which the hot exhaust gas is guided before it reaches the further exhaust line 1 on the exit side of the evaporator 2. An exhaust silencer and/or a device for the aftertreatment of the exhaust gas, for example in the form of a catalytic converter and/or a soot filter, can be integrated in the exhaust line 1, upstream or downstream of the evaporator 2, before the exhaust gas is discharged from the exhaust line 1 into the environment.

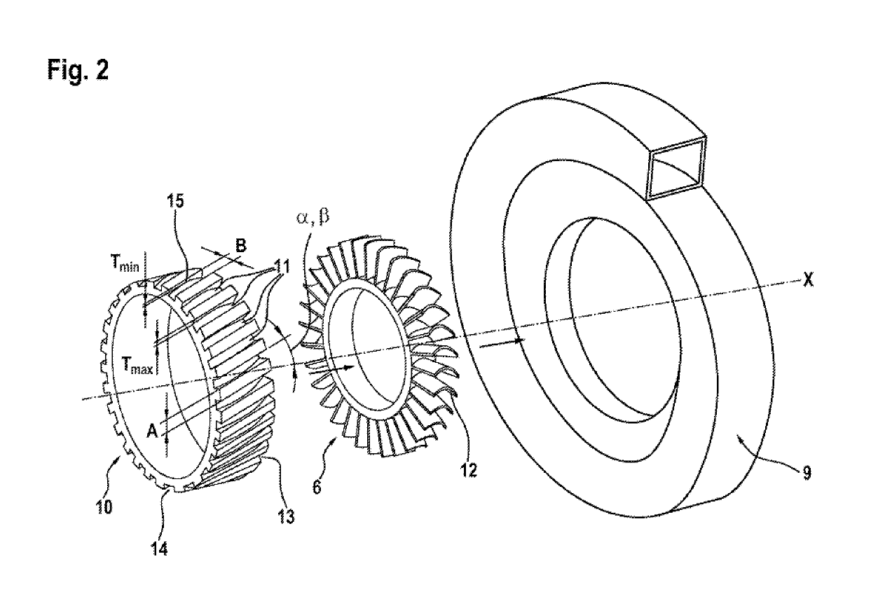

The evaporator 2 is part of a system for using waste heat from the waste heat flow of the internal combustion engine and has a working fluid circuit 3 through which there flows a working fluid, which is for example water or an organic medium such as ethanol. To that end, a pump 4 is connected into the working fluid circuit 3 and urges the working fluid through the working fluid circuit 3. The pump 4 can be operated mechanically, hydraulically or preferably electrically, it being possible to control the operation. That is to say that the pump can be switched on and switched off, at least in dependence on the operating conditions of the system. The working fluid is urged through the evaporator 2 by the pump 4 and then arrives at an expansion machine in the form of a steam turbine 5. The steam turbine 5 has a turbine which is mounted in a turbine casing and is in the form of a rotor 6 (FIG. 2) which is set in rotation by the flowing working fluid when the latter flows through it. The turbine further has a shaft 7 which is provided with bearings and on which the rotor 6 is arranged and secured, wherein the shaft 7 is moreover connected to a work machine. The work machine is for example a generator for generating electricity which may for example be stored in a battery. The energy generated in this manner in the form of electricity can be used in any way, for example when the internal combustion engine is integrated into a vehicle for operating the vehicle. However, the work machine can also for example be a hydraulic machine by means of which a hydraulic fluid is, for example, urged into a storage unit. Finally, the work machine can also be mechanical machine which is for example directly connected to a drive train of a vehicle in which the internal combustion engine is integrated.

The working fluid circuit 3 further has a condenser 8 through which there flow the working fluid and a coolant. The working fluid circuit 3 operates as follows:

The pump 4 urges the working fluid in the liquid phase into the evaporator 2, in which working fluid is converted into the gaseous phase by the hot exhaust gas. On the outlet side of the evaporator 2 is arranged the steam turbine 5, in which the gaseous working fluid expands, driving the rotor 6 of the steam turbine 5. After flowing through the steam turbine 5, the working fluid is fed to the condenser 8 in which the working fluid is cooled to the point that it reverts to the liquid phase, before it is once again fed to the pump 4.

FIG. 2 shows an inlet volute 9, a guide wheel 10 and the rotor 6 of the steam turbine, in each case in a perspective view. The inlet volute 9 forms the inlet for the steam into the steam turbine 5. In the inlet volute 9, the incoming steam is made to flow along a circular path and then reaches an inlet side 14 of the guide wheel 10. The guide wheel 10 has a number of ducts 11 (in the form of slots) which are arranged on the circumference of the guide wheel 10. By virtue of the fluidic design of the ducts 11 as nozzles in the form of de Laval nozzles, the steam flowing through these is accelerated to supersonic speed and, when it leaves the ducts 11 on an exit side 13, encounters blades 12 of the rotor 6 and drives the latter in rotation. Once the steam has flowed through the rotor 6, it is either fed to a further rotor or it is discharged from the steam turbine 5 back into the working fluid circuit 3. The ducts 11 are oriented such that the steam encounters the blades 12 of the rotor 6 at a fluidically expedient angle a on the exit side 13 with respect to the axial axis x through the steam turbine 5. To that end, the ducts 11 are for example—as shown in FIG. 2—arranged at a constant angle α=β of 15° to the axial axis through the guide wheel 10. However, the ducts 11 may also be arranged wound in the guide wheel 10. Then, the angle β changes along a duct 11 and adopts, at the exit on the exit side 13, the angle α, for example with the value 15°. However, the spacing A of the ducts 11 with respect to one another in the guide wheel 10 is at least approximately always the same. The ducts 11 all have a constant breadth B along the respective duct. The depth T of the ducts 11, by contrast, varies from the inlet side 14 via the duct center 15 to the outlet side 13. The depth T of each duct 11 has, on the inlet side 14 and the outlet side 13, a (different) maximum Tmax and, approximately in the duct center 15, a minimum Tmin. When the guide wheel 10 is in the installed state, the ducts 11 are closed in the outward direction for example by an annular wall section of the inlet, such that the steam can flow entirely and solely through the ducts 11.

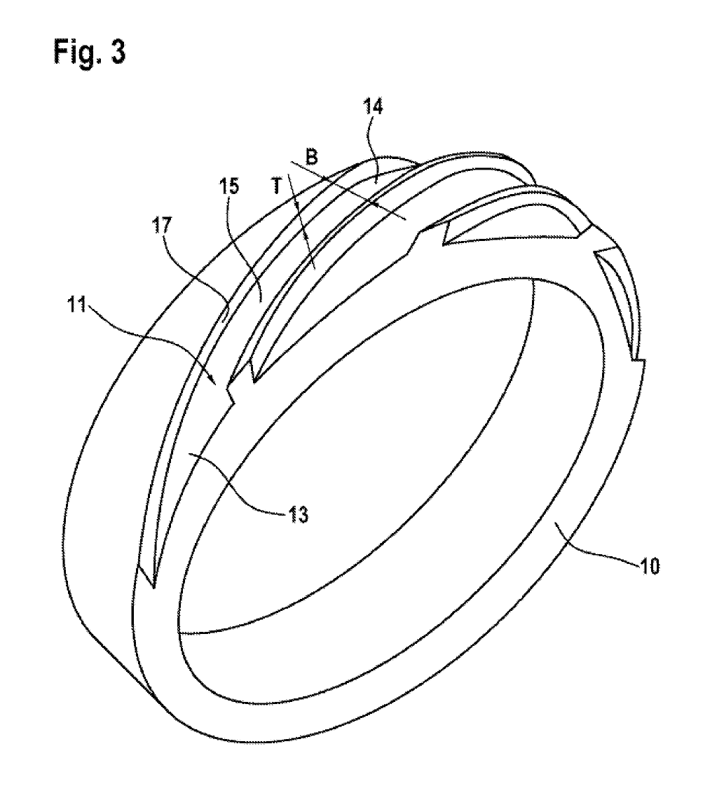

FIG. 3 shows a detailed perspective view of the guide wheel 10, wherein four adjacent ducts 11 have been machined into this guide wheel 10. It is of course possible—as shown in the guide wheel 10 in FIG. 2—for a multiplicity of ducts 11 to actually be machined into the guide wheel 10. The view according to FIG. 3 shows a plan view of the outlet side 13 of the guide wheel 10.

As already represented in detail in FIG. 2, the ducts 11 all have a constant breadth B along the respective duct. The depth T of the ducts 11, by contrast, varies from the inlet side 14 via the duct center 15 to the outlet side 13. The depth T of each duct 11 has, on the inlet side 14 and the outlet side 13, a maximum Tmax and, approximately in the duct center 15, a minimum Tmin. This simulates a de Laval nozzle.

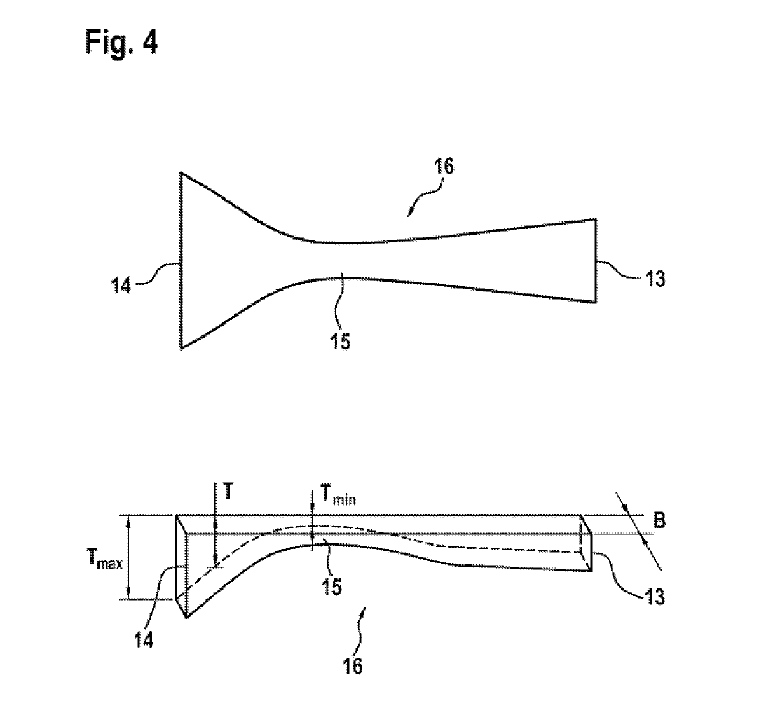

FIG. 4 shows, in the upper picture, a de Laval nozzle 16 of conventional design. This de Laval nozzle 16 has an inlet side 14 with a large area which, through a continuous narrowing of the de Laval nozzle, adopts a minimum in the rear region of the duct center 15, before the cross section area of the outlet side 13 again increases continuously. The “folded” de Laval nozzle 16 arranged there-below has the same area ratios as the de Laval nozzle 16 represented above, wherein the shape of the lower de Laval nozzle 16 has double the breadth of the upper shape. Thus, both de Laval nozzles 16 are of equal area. The shape of the lower de Laval nozzle 16 is brought about by a duct 11 formed according to the invention, with the constant breadth B and the depth T which changes along the duct. The maximum depths Tmax on the inlet side 14 and on the outlet side 13 are, as embodied previously, different. Calculations and trials have shown that the effect of the shape represented in the lower picture corresponds to that of the shape represented in the upper picture.

1. A steam turbine (5) comprising at least one turbine casing, a guide wheel (10) having at least one nozzle, and at least one rotor (6), wherein the nozzle is a duct (11) in the guide wheel (10), characterized in that the duct (11) has a constant breadth (B) and a depth (T) which varies along the duct (11).

2. The steam turbine (5) as claimed in claim 1, characterized in that the duct (11) is arranged inclined at an angle (β) in the guide wheel (10).

3. The steam turbine (5) as claimed in claim 1, characterized in that the duct (11) is arranged wound in the guide wheel (10).

4. The steam turbine (5) as claimed in claim 3, characterized in that an inlet into the duct (11) on an inlet side (14) and an outlet from the duct (11) on an outlet side (13) are arranged wound with respect to a duct center (15).

5. The steam turbine (5) as claimed in claim 4, characterized in that an angle (α) at an exit from the duct (11), at a transition to the rotor (6), is 15°.

6. The steam turbine (5) as claimed in claim 1, characterized in that the nozzle is a de Laval nozzle (16).

7. The steam turbine (5) as claimed in claim 1, characterized in that a number of nozzles are arranged in the guide wheel (10), on an external circumference thereof.

8. The steam turbine (5) as claimed in claim 7, characterized in that the nozzles have a constant spacing (A) with respect to one another along the respective duct (11).

9. The steam turbine (5) as claimed in claim 1, characterized in that a single tool is provided for creating the duct (11).

10. A method for producing a duct (11) of a nozzle of a steam turbine (5) with at least one turbine casing, a guide wheel (19) accommodating the nozzle, and at least one rotor (6), the method comprising using a single tool to introduce into the guide wheel the duct (11) with a constant breadth (B) and a depth (T) which varies along the duct (11).

11. The method as claimed in claim 10 wherein the single tool is a milling disk.
